(19) United States
(12) Patent Application Publication
(10) Pub. No.: US 2021/0323505 A1
(43) Pub. Date: Oct. 21, 2021

(54) SMART WIPER SYSTEM

(71) Applicant: Rosemount Aerospace Inc., Burnsville, MN (US)

(72) Inventors: Muralidhar Rao Bojjanapalli, Hyderabad (IN); Naveen Kumar Devarakonda, Bangalore (IN); Aswin Kumar Vallamkondu, Bangalore (IN)

(21) Appl. No.: 17/165,389

(22) Filed: Feb. 2, 2021

(30) Foreign Application Priority Data
Apr. 20, 2020 (IN) 202041016875

(51) Int. Cl. B60S 1/08; B60S 1/26; B64C 1/14

(52) U.S. Cl. CPC B60S 1/0874; B64C 1/14; B60S 1/26; B60S 1/0862

(57) ABSTRACT

A windshield wiper system includes a wiper arm, a wiper blade attached to the wiper arm, an output shaft attached to an end of the wiper arm, an actuator attached to the output shaft, a controller, a first sensor, a second sensor, and a third sensor. The controller is configured to activate the actuator, causing the output shaft to rotate and thus driving the wiper arm with the attached wiper blade in a sweeping motion across a windshield. The controller is also configured to receive signals from the first, second, and third sensors indicating the position of the wiper arm and the wiper blade.

### CROSS-REFERENCE TO RELATED APPLICATION(S)

This application claims the benefit of I.N. Provisional Application No. 202041016875 filed Apr. 20, 2020 for “SMART WIPER SYSTEM” by M. R. Bojjanapalli, N. K. Devarakonda and A. K. Vallamkondu.

### BACKGROUND

The present disclosure relates to windshield wiper systems, and in particular to a windshield wiper system used on an aircraft.

Aircraft windshield wiper systems are used to wipe and clean water or other debris from an aircraft windshield, allowing better visibility out the windshield for both the pilot and co-pilot. Currently, the rotation, sweep limits, and parking positions of the wipers are achieved by controlling the angular position of the wiper output shaft which is attached to an end of each wiper of the windshield wiper system. Software or other code is used to control the angular position of the wiper output shaft through a motor or actuator. Currently, there is no feedback from windshield wiper systems, and the theoretical position of the wiper blade may not represent the actual position of the wiper blade. Flexing of the wiper blade, degradation of components, and external forces such as higher than predicted wind velocities can cause the actual position of the wiper blade to vary from the theoretical position. If the actual position of the wiper blade varies enough, the wiper blade can sweep off the windshield and onto the frame surrounding the windshield, this is called over-sweep. When over-sweep occurs, unpredicted additional loads are applied to the wiper motor and the wiper blade causing damage to the wiper blade and shortening the useful lifespan of the wiper motor and the wiper blade.

### SUMMARY

In one example, a windshield wiper system is used on a windshield of an aircraft. The windshield wiper system includes a wiper, a first sensor, and a controller. The wiper includes a wiper arm and a wiper blade attached to a first end of the wiper arm, the wiper blade is comprised at least partially of a metal. The first sensor is positioned at a first location adjacent an inside of the windshield of the aircraft and the first sensor is configured to detect a magnetic field. The controller is connected to the first sensor and the controller is configured to receive signals from the first sensor indicating the magnitude of the magnetic field detected by the first sensor.

In another example, a method of operating a windshield wiper system for use on a windshield of an aircraft is described. The method includes detecting, by a first sensor, a magnetic field indicative of a position of a tip of a wiper blade, wherein the tip is comprised at least partially of a metal. The first sensor is positioned at a first location adjacent an inside of the windshield of the aircraft. The method also includes providing, by the first sensor, a signal to a controller indicating the magnitude of the magnetic field detected by the first sensor, wherein the controller is connected to the first sensor. The wiper blade is attached to a first end of a wiper arm.

### BRIEF DESCRIPTION OF THE DRAWINGS

FIG. 1A is a perspective view of a windshield wiper system in a first position.

FIG. 1B is a perspective view of the windshield wiper system in a second position.

FIG. 1C is a perspective view of the windshield wiper system in a third position.

FIG. 1D is a block diagram of the windshield wiper system.

### DETAILED DESCRIPTION

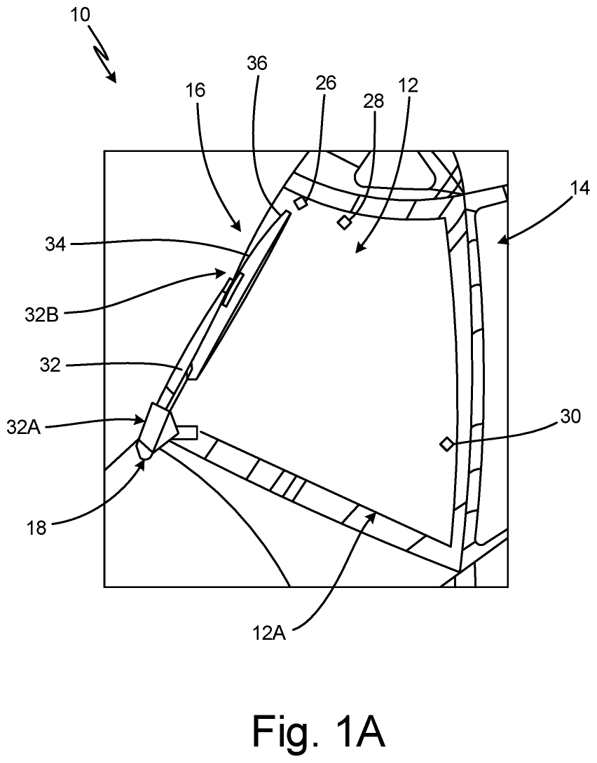

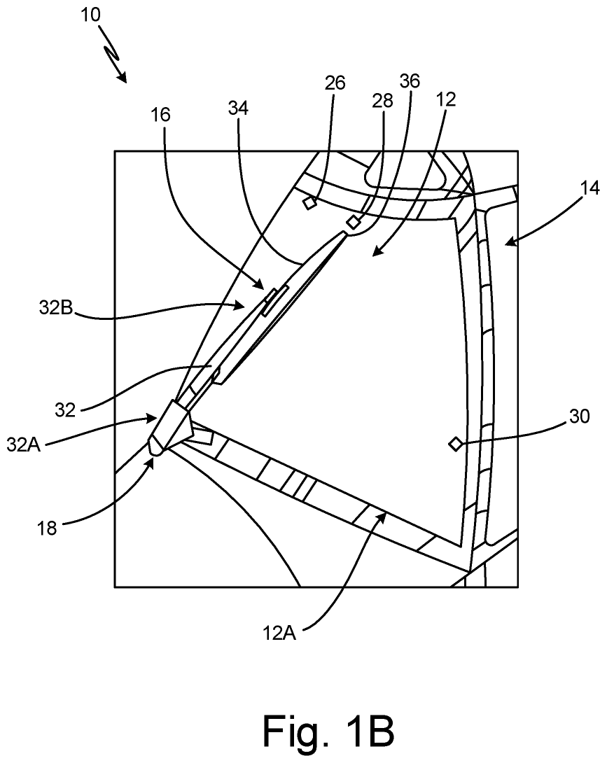

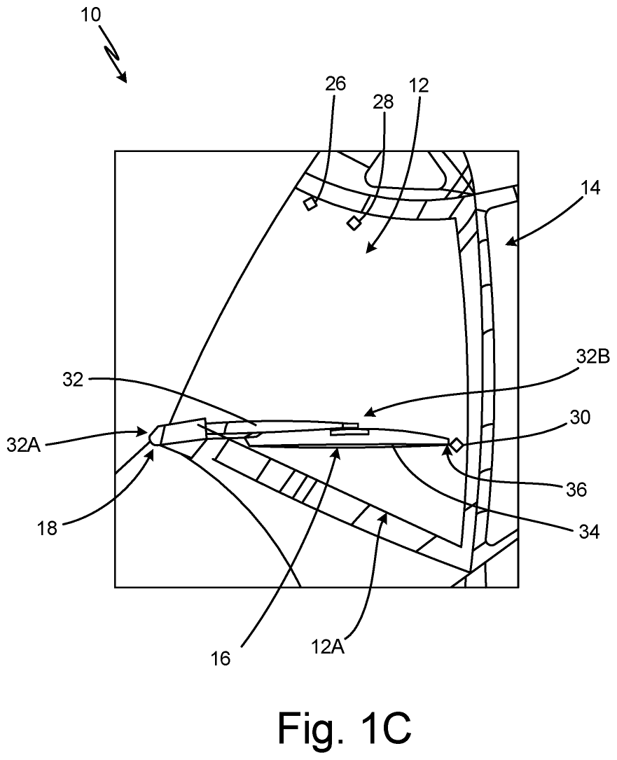

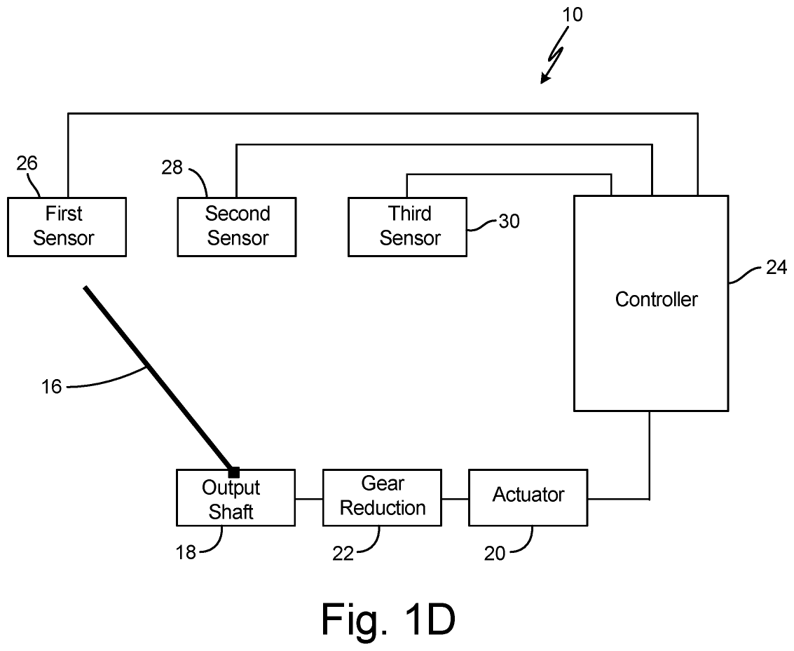

FIG. 1A is a perspective view of windshield wiper system (WWS) 10 in a first position on windshield 12 of aircraft 14. FIG. 1B is a perspective view of WWS 10 in a second position on windshield 12 of aircraft 14. FIG. 1C is a perspective view of WWS 10 in a third position on windshield 12 of aircraft 14. FIG. 1D is a block diagram of WWS 10. FIGS. 1A-1D will be discussed together. WWS 10 includes wiper 16, output shaft 18, actuator 20, gear reduction 22, controller 24, first sensor 26, second sensor 28, and third sensor 30. WWS 10 is installed on windshield 12 of aircraft 14 and is configured to clear windshield 12 of rain or other debris with greater accuracy than could be achieved using previous windshield wiper systems.

Wiper 16 includes wiper arm 32 and wiper blade 34. Wiper blade 34 is attached to second end 32B of wiper arm 32. Wiper blade 34 includes tip 36 positioned at a distal end of wiper blade 34. Tip 36 is configured to come in close proximity (within one inch) with first sensor 26, second sensor 28, and third sensor 30 as wiper 16 sweeps across windshield 12. Wiper arm 32 and wiper blade 34 can both be constructed at least partially from a polymer and at least partially from a metal. Further, tip 36 of wiper blade 34 can be constructed at least partially from a metal. Wiper arm 32 is attached to output shaft 18 at first end 32A of wiper arm 32 through a standard mechanical connection. Output shaft 18 extends through a body portion of aircraft 14 near windshield 12, but not through windshield 12. Output shaft 18 is configured to rotate about its central axis, providing rotational energy to first end 32A of wiper arm 32, which in turn forces wiper 16 to traverse across windshield 12 in a sweeping motion.

Actuator 20 is attached to output shaft 18 within the body portion of aircraft 14 and opposite from the attached first end 32A of wiper arm 32. Actuator 20 is configured to provide rotational energy to output shaft 18, rotating output shaft 18 in the process. The rotation of output shaft 18 forces wiper 16 to traverse across windshield 12 in a sweeping motion, therefore actuator 20 provides the energy necessary to drive motion of wiper 16. In the embodiment shown, actuator 20 is a brushless direct current motor. In another embodiment, actuator 20 can be a brushed direct current motor or any other motor configured to provide rotational energy to output shaft 18. Further, actuator 20 is a bi-directional motor that can operate in both directions, allowing output shaft 18, wiper arm 32, and wiper blade 34 to move in both directions. Actuator 20 is attached to output shaft 18 through gear reduction 22, in which gear reduction 22 is positioned between output shaft 18 and actuator 20. In other words, gear reduction 22 is positioned within the body of aircraft 14, attached at one end to output shaft 18, and attached at the other end to actuator 20. Gear reduction 22 has a large gear ratio or gear reduction, meaning that many rotations of actuator 20 will cause only a few degrees of rotation of wiper 16. Gear reduction 22 is configured to allow for precise angular rotation of wiper 16.

Controller 24 is positioned within the body portion of aircraft 14 and controller 24 is connected to actuator 20, first sensor 26, second sensor 28, and third sensor 30. Controller 24 can be connected to each component through electrical wires or a wireless connection to send and receive signals from each of actuator 20, first sensor 26, second sensor 28, and third sensor 30. More specifically, controller 24 is connected to actuator 20 through a wired or wireless connection and controller 24 is configured to send signals to actuator 20 to control operation of actuator 20. Likewise, controller 24 is connected to each of first sensor 26, second sensor 28, and third sensor 30 through a wired or wireless connection and controller 24 is configured to send signals to and receive signals from each of first sensor 26, second sensor 28, and third sensor 30, discussed in detail below.

First sensor 26 is an inductive sensor that is configured to detect a magnetic field and/or a change in a magnetic field near first sensor 26. More specifically, an electrical current flows through first sensor 26, creating a magnetic field around first sensor 26. When a metal component in close proximity moves closer to or away from first sensor 26 the magnetic field of first sensor 26 will change, indicating that a metal component is moving near first sensor 26 or moving away from first sensor 26. In the embodiment described, close proximity means within one inch of first sensor 26. In another embodiment, close proximity could mean more than or less than within one inch of first sensor 26. First sensor 26 is positioned at a first location adjacent an inner surface of windshield 12 of aircraft 14. The first location is a position near tip 36 of wiper blade 34 when wiper 16 is in a parked position. Wiper 16 is in a parked position when wiper 16 is approximately perpendicular with bottom edge 12A of windshield 12. When wiper 16 is in the parked position, wiper 16 is stationary and not currently being used to clear rain or other debris from windshield 12 of aircraft 14. First sensor 26 is configured to detect the magnitude of the magnetic field near first sensor 26 and send that information to controller 24. The detected magnetic field or change in magnetic field can be used to identify the position of tip 36 of wiper blade 34 on windshield 12 of aircraft 14.

Second sensor 28 is an inductive sensor that is configured to detect a magnetic field and/or a change in a magnetic field near second sensor 28. More specifically, an electrical current flows through second sensor 28, creating a magnetic field around second sensor 28. When a metal component in close proximity moves closer to or away from second sensor 28 the magnetic field of second sensor 28 will change, indicating that a metal component is moving near second sensor 28 or moving away from second sensor 28. In the embodiment described, close proximity means within one inch of second sensor 28. In another embodiment, close proximity could mean more than or less than within one inch of second sensor 28. Second sensor 28 is positioned at a second location adjacent an inner surface of windshield 12 of aircraft 14. The second location is a position near tip 36 of wiper blade 34 when wiper 16 is sweeping across windshield 12. When wiper 16 is in the second location, wiper 16 is sweeping across windshield 12 and currently being used to clear rain or other debris from windshield 12 of aircraft 14. Second sensor 28 is configured to detect the magnitude of the magnetic field near second sensor 28 and send that information to controller 24. The detected magnetic field or change in magnetic field can be used to identify the position of tip 36 of wiper blade 34 on windshield 12 of aircraft 14.

Third sensor 30 is an inductive sensor that is configured to detect a magnetic field and/or a change in a magnetic field near third sensor 30. More specifically, an electrical current flows through third sensor 30, creating a magnetic field around third sensor 30. When a metal component in close proximity moves closer to or away from third sensor 30 the magnetic field of third sensor 30 will change, indicating that a metal component is moving near third sensor 30 or moving away from third sensor 30. In the embodiment described, close proximity means within one inch of third sensor 30. In another embodiment, close proximity could mean more than or less than within one inch of third sensor 30. Third sensor 30 is positioned at a third location adjacent an inner surface of windshield 12 of aircraft 14. The third location is a position near tip 36 of wiper blade 34 when wiper 16 reaches its sweeping limit and is about to change its sweeping direction. When wiper 16 is in the third location, wiper 16 has completed its sweeping path in a first direction and is reversing its sweeping path in a second direction across windshield 12. Third sensor 30 is configured to detect the magnitude of the magnetic field near third sensor 30 and send that information to controller 24. The detected magnetic field or change in magnetic field can be used to identify the position of tip 36 of wiper blade 34 on windshield 12 of aircraft 14.

In operation, wiper 16 begins in the parked position and remains in the parked position until a pilot, co-pilot, or an automated system activates WWS 10. Once WWS 10 is activated, wiper 16 sweeps across windshield 12 toward the second location and second sensor 28. As tip 36 of wiper blade 34 sweeps closer to second sensor 28, the magnitude of the magnetic field around second sensor 28 begins to change due to the metal in tip 36. The data collected/detected by second sensor 28 is then sent to controller 24 for processing. Wiper 16 continues to sweep past second sensor 28 in the direction of third sensor 30. As tip 36 of wiper blade 34 sweeps closer to third sensor 30, the magnitude of the magnetic field around third sensor 30 begins to change due to the metal in tip 36. The data collected/detected by third sensor 30 is then sent to controller 24 for processing. Once wiper 16 reaches its sweep limits near third sensor 30, wiper 16 will reverse directions and sweep in the direction of second sensor 28. The sweep limits are coded into the software of controller 24 and define how far wiper 16 will sweep in each direction. The back and forth sweeping motion is continued to clean water or other debris from windshield 12 until WWS 10 is deactivated by the pilot, co-pilot, or an automated system.

Controller 24 processes the incoming data from first sensor 26, second sensor 28, and third sensor 30 and uses the data to identify the location of tip 36 of wiper blade 34. In previous windshield wiper systems, the sweep limits coded into controller 24 were used to control the position of wiper 16, but the coded position does not always represent the actual position of wiper 16 on windshield 12. Due to unpredicted forces, such as high wind forces, flexing of wiper blade 34, or degradation of parts of WWS 10, wiper 16 can either under-sweep or over-sweep. In an under-sweep condition, wiper 16 is not reaching its coded sweep limits before reversing direction. Thus, when under-sweep occurs, windshield 12 is not being sufficiently cleared of water or other debris. In an over-sweep condition, wiper 16 is overshooting its coded sweep limits and is traveling beyond the perimeter of windshield 12 and onto the frame surrounding windshield 12. When over-sweep occurs, unpredicted additional loads are applied to actuator 10 and wiper blade 34 causing damage to actuator 20 and wiper blade 34 and shortening the useful lifespan of actuator 10 and wiper blade 34. As such, neither an under-sweep condition nor an over-sweep condition are desirable.

WWS 10 remedies the issue of under-sweep and over-sweep by using data from first sensor 26, second sensor 28, and third sensor 30 to accurately identify the actual location of tip 36 of wiper blade 34 in real time. If under sweep is occurring, controller 24 can send a signal to actuator 20 to continue sweeping in the first direction until tip 36 reaches third sensor 30. Likewise, if under sweep is occurring in the other direction, controller 24 can send a signal to actuator 20 to continue sweeping in the second direction until tip 36 reaches first sensor 26. If over-sweep is occurring, controller 24 can send a signal to actuator 20 to stop sweeping in the first direction because tip 36 has already reached third sensor 30 and its coded sweep limit. Likewise, if over-sweep is occurring in the other direction, controller 24 can send a signal to actuator 20 to stop sweeping in the second direction because tip 36 has already reached second sensor 28 and its coded sweep limit. Thus, WWS 10 is utilized to ensure that wiper 16 is operating correctly and is reaching its coded sweeping limits. WWS 10 uses the data from first sensor 26, second sensor 28, and third sensor 30 to identify the actual location of tip 36 on windshield 12 and then adjust the sweeping of wiper 16 to come within plus or minus one degree of the software coded sweeping limits.

WWS 10 improves the accuracy and performance of the overall wiper system. Any deviation in tip 36 position due to external loads or faulty externals (actuator/gearbox slip) which cannot be sensed by the software in controller 24 will be detected by first sensor 26, second sensor 28, and third sensor 30, then controller 24 will adjust the sweep limits accordingly to remedy the issue. WWS 10 is an intelligent closed loop system used to control the sweep limits of wiper 16 in an efficient and simple solution. WWS 10 can be used with existing wipers 16 because no sensor needs to be installed on the wipers themselves, rather the already present metal in wiper blade 34 is used to create a change in the magnetic field near first sensor 26, second sensor 28, and third sensor 30. Further, unlike previous infrared sensing systems, dirt or other debris near the sensors does not alter the performance of WWS 10. The magnetic field near first sensor 26, second sensor 28, and third sensor 30 will still change and function correctly even if dirt or other debris covers the sensors. WWS 10 is a simple solution that meets customer requirements and controls the angular position of wiper 16 to within plus or minus one degree of the software coded sweep limits. WWS 10 will extend the lifespan of wiper 16 by preventing unexpected forces and loads on wiper 16 due to over-shoot condition, ultimately resulting in cost savings to the customer. WWS 10 provides many benefits over previous aircraft windshield wiper systems.

### Discussion of Possible Embodiments

The following are non-exclusive descriptions of possible embodiments of the present invention.

A windshield wiper system for use on a windshield of an aircraft, the windshield wiper system comprising a wiper comprising a wiper arm and a wiper blade attached to a first end of the wiper arm, wherein the wiper blade is comprised at least partially of a metal; a first sensor positioned at a first location adjacent an inside of the windshield of the aircraft, wherein the first sensor is configured to detect a magnetic field; and a controller connected to the first sensor, wherein the controller is configured to receive signals from the first sensor indicating the magnitude of the magnetic field detected by the first sensor.

The windshield wiper system of the preceding paragraph can optionally include, additionally and/or alternatively, any one or more of the following features, configurations and/or additional components:

A further embodiment of the foregoing windshield wiper system, wherein the wiper blade includes a tip, and wherein the tip is comprised at least partially of a metal.

A further embodiment of the foregoing windshield wiper system, wherein first sensor is configured to identify the position of the tip of the wiper blade on the windshield of the aircraft.

A further embodiment of the foregoing windshield wiper system, and further comprising an output shaft attached to a second end of the wiper arm; and an actuator attached to the output shaft; wherein the actuator is configured to rotate the output shaft which in turn forces the wiper arm and attached wiper blade to sweep across the windshield of the aircraft.

A further embodiment of the foregoing windshield wiper system, wherein the actuator is a brushless direct current motor, and wherein a gear reduction is attached to and positioned between the output shaft and the actuator.

A further embodiment of the foregoing windshield wiper system, wherein the controller is connected to the actuator, and wherein the controller is configured to send signals to the actuator to control operation of the actuator.

A further embodiment of the foregoing windshield wiper system, and further comprising a second sensor positioned at a second location adjacent an inside of the windshield of the aircraft, wherein the second sensor is configured to detect a magnetic field.

A further embodiment of the foregoing windshield wiper system, and further comprising a third sensor positioned at a third location adjacent an inside of the windshield of the aircraft, wherein the third sensor is configured to detect a magnetic field.

A further embodiment of the foregoing windshield wiper system, wherein the controller is connected to the second sensor, and wherein the controller is configured to receive signals from the second sensor indicating the magnitude of the magnetic field detected by the second sensor; and the controller is connected to the third sensor, and wherein the controller is configured to receive signals from the third sensor indicating the magnitude of the magnetic field detected by the third sensor.

A further embodiment of the foregoing windshield wiper system, wherein the first sensor, the second sensor, and the third sensor are configured to identify the position of the wiper on the windshield of the aircraft.

A further embodiment of the foregoing windshield wiper system, wherein a method of operating a windshield wiper system for use on a windshield of an aircraft, the method comprising detecting, by a first sensor, a magnetic field indicative of a position of a tip of a wiper blade, wherein the tip is comprised at least partially of a metal, and wherein the first sensor is positioned at a first location adjacent an inside of the windshield of the aircraft; and providing, by the first sensor, a signal to a controller indicating the magnitude of the magnetic field detected by the first sensor, wherein the controller is connected to the first sensor; wherein the wiper blade is attached to a first end of a wiper arm.

A further embodiment of the foregoing windshield wiper system, and further comprising rotating, by an actuator, an output shaft attached to a second end of the wiper arm;

wherein the actuator is attached to the output shaft; and wherein rotation of the output shaft forces the wiper arm with the attached wiper blade to sweep across the windshield of the aircraft.

A further embodiment of the foregoing windshield wiper system, wherein the actuator is a brushless direct current motor, and wherein a gear reduction is attached to and positioned between the output shaft and the actuator.

A further embodiment of the foregoing windshield wiper system, wherein the controller is connected to the actuator, and wherein the controller is configured to send signals to the actuator to control operation of the actuator.

A further embodiment of the foregoing windshield wiper system, wherein the controller is configured to receive the signal from the first sensor indicating the position of the tip of the wiper blade and then send a signal to the actuator to adjust the position of the wiper arm and wiper blade through rotation of the output shaft attached to the actuator.

A further embodiment of the foregoing windshield wiper system, and further comprising detecting, by a second sensor, a magnetic field indicative of a position of the tip of the wiper blade, wherein the second sensor is positioned at a second location adjacent the inside of the windshield of the aircraft.

A further embodiment of the foregoing windshield wiper system, and further comprising detecting, by a third sensor, a magnetic field indicative of a position of the tip of the wiper blade, wherein the third sensor is positioned at a third location adjacent the inside of the windshield of the aircraft.

A further embodiment of the foregoing windshield wiper system, wherein the first sensor, the second sensor, and the third sensor are an inductive sensor.

A further embodiment of the foregoing windshield wiper system, and further comprising providing, by the second sensor, a signal to the controller indicating the magnitude of the magnetic field detected by the second sensor, wherein the controller is connected to the second sensor; and providing, by the third sensor, a signal to the controller indicating the magnitude of the magnetic field detected by the third sensor, wherein the controller is connected to the third sensor.

A further embodiment of the foregoing windshield wiper system, wherein a wiper comprising a wiper arm and a wiper blade attached to a first end of the wiper arm, wherein the wiper blade is comprised at least partially of a metal; a first sensor positioned at a first location adjacent an inside of the windshield of the aircraft, wherein the first sensor is configured to detect a magnetic field; a second sensor positioned at a second location adjacent the inside of the windshield of the aircraft, wherein the second sensor is configured to detect a magnetic field; a third sensor positioned at a third location adjacent the inside of the windshield of the aircraft, wherein the third sensor is configured to detect a magnetic field; an output shaft attached to a second end of the wiper arm; an actuator attached to the output shaft, wherein the actuator is configured to rotate the output shaft which in turn forces the wiper arm and attached wiper blade to sweep across the windshield of the aircraft; and a controller connected to the first sensor, second sensor, and third sensor, wherein the controller is configured to receive signals from the sensors indicating the magnitude of the magnetic field detected by the sensors; wherein the controller is connected to the actuator, and wherein the controller is configured to send signals to the actuator to control operation of the actuator; and wherein the first sensor, the second sensor, and the third sensor are configured to identify the position of the wiper on the windshield of the aircraft.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A windshield wiper system for use on a windshield of an aircraft, the windshield wiper system comprising:
a wiper comprising a wiper arm and a wiper blade attached to a first end of the wiper arm, wherein the wiper blade is comprised at least partially of a metal;
a first sensor positioned at a first location adjacent an inside of the windshield of the aircraft, wherein the first sensor is configured to detect a magnetic field; and
a controller connected to the first sensor, wherein the controller is configured to receive signals from the first sensor indicating the magnitude of the magnetic field detected by the first sensor.

2. The windshield wiper system of claim 1, wherein the wiper blade includes a tip, and wherein the tip is comprised at least partially of a metal.

3. The windshield wiper system of claim 2, wherein first sensor is configured to identify the position of the tip of the wiper blade on the windshield of the aircraft.

4. The windshield wiper system of claim 1 and further comprising:
an output shaft attached to a second end of the wiper arm; and
an actuator attached to the output shaft;
wherein the actuator is configured to rotate the output shaft which in turn forces the wiper arm and attached wiper blade to sweep across the windshield of the aircraft.

5. The windshield wiper system of claim 4, wherein the actuator is a brushless direct current motor, and wherein a gear reduction is attached to and positioned between the output shaft and the actuator.

6. The windshield wiper system of claim 4, wherein the controller is connected to the actuator, and wherein the controller is configured to send signals to the actuator to control operation of the actuator.

7. The windshield wiper system of claim 1 and further comprising:
a second sensor positioned at a second location adjacent an inside of the windshield of the aircraft, wherein the second sensor is configured to detect a magnetic field.

8. The windshield wiper system of claim 7 and further comprising:
a third sensor positioned at a third location adjacent an inside of the windshield of the aircraft, wherein the third sensor is configured to detect a magnetic field.

9. The windshield wiper system of claim 8, wherein the first sensor, the second sensor, and the third sensor are an inductive sensor.

10. The windshield wiper system of claim 8, wherein:
the controller is connected to the second sensor, and wherein the controller is configured to receive signals from the second sensor indicating the magnitude of the magnetic field detected by the second sensor; and
the controller is connected to the third sensor, and wherein the controller is configured to receive signals from the third sensor indicating the magnitude of the magnetic field detected by the third sensor.

11. The windshield wiper system of claim 10, wherein the first sensor, the second sensor, and the third sensor are configured to identify the position of the wiper on the windshield of the aircraft.

12. A method of operating a windshield wiper system for use on a windshield of an aircraft, the method comprising:
detecting, by a first sensor, a magnetic field indicative of a position of a tip of a wiper blade, wherein the tip is comprised at least partially of a metal, and wherein the first sensor is positioned at a first location adjacent an inside of the windshield of the aircraft; and
providing, by the first sensor, a signal to a controller indicating the magnitude of the magnetic field detected by the first sensor, wherein the controller is connected to the first sensor;
wherein the wiper blade is attached to a first end of a wiper arm.

12. The method of claim 11 and further comprising:
rotating, by an actuator, an output shaft attached to a second end of the wiper arm;
wherein the actuator is attached to the output shaft; and
wherein rotation of the output shaft forces the wiper arm with the attached wiper blade to sweep across the windshield of the aircraft.

13. The method of claim 12, wherein the actuator is a brushless direct current motor, and wherein a gear reduction is attached to and positioned between the output shaft and the actuator.

14. The method of claim 12, wherein the controller is connected to the actuator, and wherein the controller is configured to send signals to the actuator to control operation of the actuator.

15. The method of claim 14, wherein the controller is configured to receive the signal from the first sensor indicating the position of the tip of the wiper blade and then send a signal to the actuator to adjust the position of the wiper arm and wiper blade through rotation of the output shaft attached to the actuator.

16. The method of claim 11, and further comprising:
detecting, by a second sensor, a magnetic field indicative of a position of the tip of the wiper blade, wherein the second sensor is positioned at a second location adjacent the inside of the windshield of the aircraft.

17. The method of claim 16, and further comprising:
detecting, by a third sensor, a magnetic field indicative of a position of the tip of the wiper blade, wherein the third sensor is positioned at a third location adjacent the inside of the windshield of the aircraft.

18. The method of claim 17, wherein the first sensor, the second sensor, and the third sensor are an inductive sensor.

19. The method of claim 18, and further comprising:
providing, by the second sensor, a signal to the controller indicating the magnitude of the magnetic field detected by the second sensor, wherein the controller is connected to the second sensor; and
providing, by the third sensor, a signal to the controller indicating the magnitude of the magnetic field detected by the third sensor, wherein the controller is connected to the third sensor.

20. A windshield wiper system for use on a windshield of an aircraft, the windshield wiper system comprising:
a wiper comprising a wiper arm and a wiper blade attached to a first end of the wiper arm, wherein the wiper blade is comprised at least partially of a metal;
a first sensor positioned at a first location adjacent an inside of the windshield of the aircraft, wherein the first sensor is configured to detect a magnetic field;
a second sensor positioned at a second location adjacent the inside of the windshield of the aircraft, wherein the second sensor is configured to detect a magnetic field;
a third sensor positioned at a third location adjacent the inside of the windshield of the aircraft, wherein the third sensor is configured to detect a magnetic field;
an output shaft attached to a second end of the wiper arm;
an actuator attached to the output shaft, wherein the actuator is configured to rotate the output shaft which in turn forces the wiper arm and attached wiper blade to sweep across the windshield of the aircraft; and
a controller connected to the first sensor, second sensor, and third sensor, wherein the controller is configured to receive signals from the sensors indicating the magnitude of the magnetic field detected by the sensors;
wherein the controller is connected to the actuator, and wherein the controller is configured to send signals to the actuator to control operation of the actuator; and
wherein the first sensor, the second sensor, and the third sensor are configured to identify the position of the wiper on the windshield of the aircraft.
